(19) United States
(12) Patent Application Publication
(10) Pub. No.: US 2023/0142970 A1
(43) Pub. Date: May 11, 2023

(54) METHOD FOR PRODUCING A POLARIZER FILM ASSEMBLY WITH A CONTINUOUS FILM LAYER

(71) Applicant: Dell Products L.P., Round Rock, TX (US)

(72) Inventors: Laurent Andrew Regimbal, Georgetown, TX (US); Mark Andrew Schwager, Cedar Park, TX (US)

(21) Appl. No.: 17/454,256

(22) Filed: Nov. 10, 2021

(51) Int. Cl. B29D 11/00; G02F 1/1335

(52) U.S. Cl. CPC B29D 11/00644; G02F 1/133528; B29K 2029/04

(57) ABSTRACT

A method for manufacturing a polarizer film assembly for a display assembly in an information handling system comprises forming a mask on a base film substrate and creating a set of optical targets on the base film substrate prior to applying the dye to the base film substrate. The dye adheres to unmasked areas to form a polarizer film, but the mask prevents the dye from adhering to masked areas, forming a set of non-polarized areas. The set of optical targets may include fiducials for aligning a cutter to the base film substrate for cutting the borders of the base layer substrate such that the polarizer film assembly forms a continuous surface with non-polarized areas positioned relative to a camera or other optical sensor.

### BACKGROUND

### Field of the Disclosure

This disclosure relates generally to portable information handling systems and, more particularly, to methods of producing polarizer film assemblies and continuous polarizer film layers.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems such as notebooks are used frequently for teleconferencing and other video communication. These portable information handling systems typically have a hinge-up display assembly to display information to a user (such as a video display displaying video of a person using another information handling system) and a camera to capture video of the user for sending to the other information handling system. The camera is typically deployed at the top center of a hinge-up/display assembly to capture video of the user positioned in front of the portable information handling system.

Typically, the camera is located above the LCD panel and behind a cosmetic bezel (non-touch system) or a protective cover glass (touch systems).

### SUMMARY

Embodiments disclosed herein may be generally directed to portable information handling systems and particularly to portable information handling systems with display assemblies with integrated optical sensors.

Embodiments disclosed herein may be directed to a method for producing a polarizer film assembly for a display assembly of an information handling system, wherein the display assembly may include a camera or other I/O component with functionality that is negatively affected by a polarizer film.

Embodiments of a method of manufacturing a polarizer film assembly for a display assembly having a display assembly width and a display assembly height comprise forming a mask on a base film substrate to form a set of masked areas and a set of unmasked areas, wherein at least one masked area corresponds to a position of an optical sensor in the display assembly. The method further comprises creating a set of optical targets on the base film substrate and applying a dye to the base film substrate to form a polarizer film on the set of unmasked areas, wherein the set of masked areas prevent the dye from adhering to the base film substrate. The method further comprises aligning the base film substrate relative to a cutter based on the set of optical targets and cutting the base film substrate relative to the set of optical targets to form a continuous polarizer film assembly with a polarizer film assembly width substantially equal to the display assembly width and a polarizer film assembly height substantially equal to the display assembly height.

In some embodiments, forming a mask on a base film substrate comprises depositing a material on the base film substrate prior to prior to applying the dye to the base film substrate to prevent the dye from adhering to the base film substrate. In some embodiments, forming a mask on a base film substrate comprises forming a continuous strip that runs the full length of the roll of base film substrate. The strip may form a top border of the polarizer layer. Forming the strip may include printing or depositing a material on the roll of base film substrate as the roll of base film substrate is unrolled.

In some embodiments, forming a mask on a base film substrate by depositing a material comprises printing on the base film substrate prior to applying the dye to the base film substrate to prevent the dye from adhering to the base film substrate. In some embodiments, the method comprises removing the mask after applying the dye.

In some embodiments, forming a mask on a base film substrate comprises modifying the base film substrate to prevent the dye from adhering to the base film substrate. In some embodiments, modifying the base film substrate comprises polishing the base film substrate to form the set of masked areas. In some embodiments, modifying the base film substrate comprises etching the base film substrate to form the set of masked areas. In some embodiments, modifying the base film substrate comprises etching or polishing a continuous strip that runs the full length of the roll of base film substrate.

In some embodiments, creating a set of optical targets on the base film substrate comprises creating a set of borders such that, after stretching and other processing steps, the borders correspond to the display assembly width and the display assembly height and cutting the base film substrate relative to the set of optical targets comprises cutting along the set of borders.

In some embodiments, creating a set of optical targets on the base film substrate comprises creating a set of fiducials inside or outside the set of borders, wherein aligning the base film substrate relative to a cutter based on the set of optical targets comprises aligning the base film substrate based on the set of fiducials.

In some embodiments, a continuous strip of material formed by depositing a material or modifying the base film substrate may be used as an optical target in the set of optical targets.

### BRIEF DESCRIPTION OF THE DRAWINGS

For a more complete understanding of the invention and its features and advantages, reference is now made to the following description, taken in conjunction with the accompanying drawings, in which:

FIG. 1 is a perspective exploded view of a display assembly for an information handling system having a camera or other optical sensor;

FIG. 2 is a top view of a sheet of base film substrate configured with a set of areas for polarizing, a set of areas for not polarizing, and a set of optical targets for ensuring a polarizer film assembly formed from the base film substrate has non-polarized areas positioned relative to an optical sensor, according to one embodiment;

FIG. 3 is a flow diagram of a method for manufacturing one embodiment of a polarizer film assembly for assembly in a display assembly for an information handling system having a camera;

FIG. 4 is a top view of a base film substrate in which all areas are polarized; and

FIG. 5 is a flow diagram of a common approach for manufacturing a polarizer film assembly for use in a display assembly for an information handling system.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and one or more video displays. The information handling system may also include one or more buses operable to transmit communication between the various hardware components.

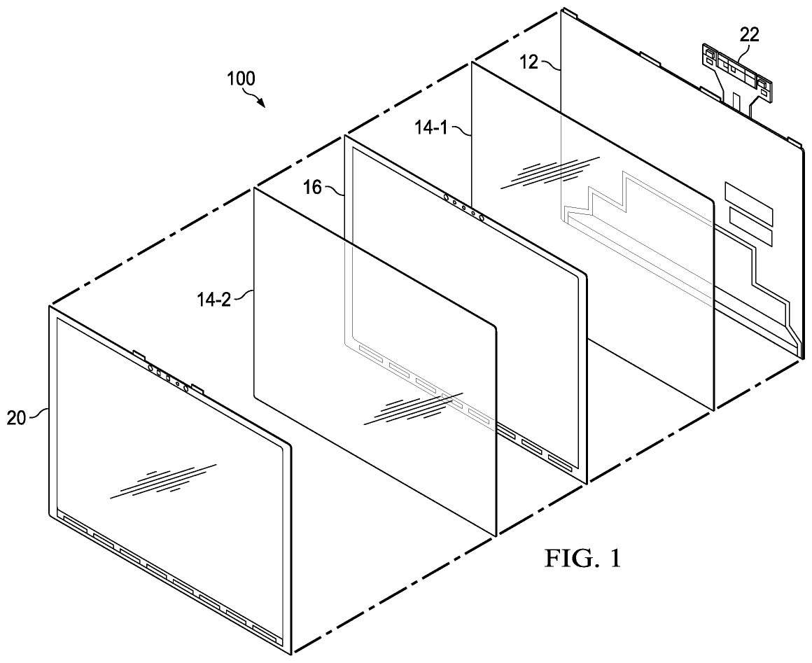

Particular embodiments are best understood by reference to FIGS. 1-5, wherein like numbers are used to indicate like and corresponding parts.

FIG. 1 depicts an exploded perspective view of display assembly 100 comprising multiple layers including backlight panel 12, rear polarizer film assembly 14-1, LCD cell layer 16 and front polarizer film assembly 14-2. In some information handling systems, display assembly 100 may include bezel 20, discussed in more detail below.

Backlight panel 12 may comprise circuits and electronic components configured for backlighting images displayed on display assembly 100. As depicted in FIG. 1, optical sensor 22 may form part of backlight panel 12. In some embodiments, circuits in backlight panel 12 may also control the display of images and text in liquid crystal display (LCD) panel 16.

Liquid Crystal Display (LCD) layer 16 comprises circuits and electronic components configured for displaying images and text in black and white and color.

Polarizer films are often necessary for the proper function of LCD layer 16. Front and rear polarizer film assemblies 14-1, 14-2, each comprising a polarizer film formed on a base film substrate, work in conjunction with the electronically controlled liquid crystal array in LCD layer 16 and backlight panel 12 to display text and images in black and white and color on display assembly 100.

### Polarizer Films Negatively Affect Performance of Cameras

Polarizer films may improve the display of text and images on display assembly 100. However, polarizer films typically have a transmissivity of approximately 40% in the visible spectrum, which causes significant difficulties for an information handling system to capture quality images from optical sensor 22, especially in low light conditions. The negative effects may include darkening of colors or oversaturation of colors and blurring of text, for example. The negative effects generally cannot be corrected by processing algorithms.

### Non-Touch Display Assemblies

Some information handling systems comprise display assemblies 100 without touch screen functionality (i.e., non-touch displays). In some of these information handling systems, front layer 20 comprises a bezel that extends to the height of display assembly 100 but polarizer film assemblies 14 extend to a height less than the height of optical sensor 22 such that the functionality of optical sensor 22 is unaffected by the polarizer film assembly 14, wherein front layer 20 provides a continuous surface for display assembly 100.

### Touch Display Assemblies

With the emergence of display assemblies 110 with touchscreen functionality (i.e., touch displays or touchscreens), some information handling systems 100 are manufactured with front layer 20 comprising a protective cover glass as a continuous layer over the entire height and width of display assembly 100. In some of these information handling systems, front layer 20 may extend to the height of display assembly 100 but polarizer film assembly 14 extends to a height less than the height of optical sensor 22 such that the functionality of optical sensor 22 is unaffected by the polarizer film assembly 14, wherein front layer 20 provides a continuous surface for display assembly 100 and protects touch screen components.

A bezel and a cover glass may protect other layers and touchscreen components in display assembly 100 but add weight and cost. In some information handling systems, front layer 20 may not be present. In some of these information handling systems, polarizer film assemblies 14 may extend to a height less than the height of optical sensor 22 such that the functionality of optical sensor 22 is unaffected by the polarizer film assembly 14. However, a user may feel a discontinuous surface of display assembly 100.

### Edge-to-Edge Displays

With a push to produce portable information handling systems with edge-to-edge display areas, there is no bezel 20 and display assemblies 100 with cameras 22 or other optical sensors must include polarizer film assemblies 14 that do not affect the capability of optical sensor 22 to capture images or other optical information. A front polarizer film assembly 14-1 may extend the full height and width of the display assembly 100 and would need a non-polarizer area in front of a camera, but a rear polarizer film assembly 14-2 that does not extend the full height of the display assembly would not need a non-polarizer area.

Embodiments disclosed herein may include a polarizer film assembly 14 for use in a display assembly 100, wherein the polarizer film assembly 14 comprises a base film substrate that may be generally covered by a polarizer film but with a set of non-polarized areas corresponding to the position of optical sensors 22 that may be affected by polarizer films.

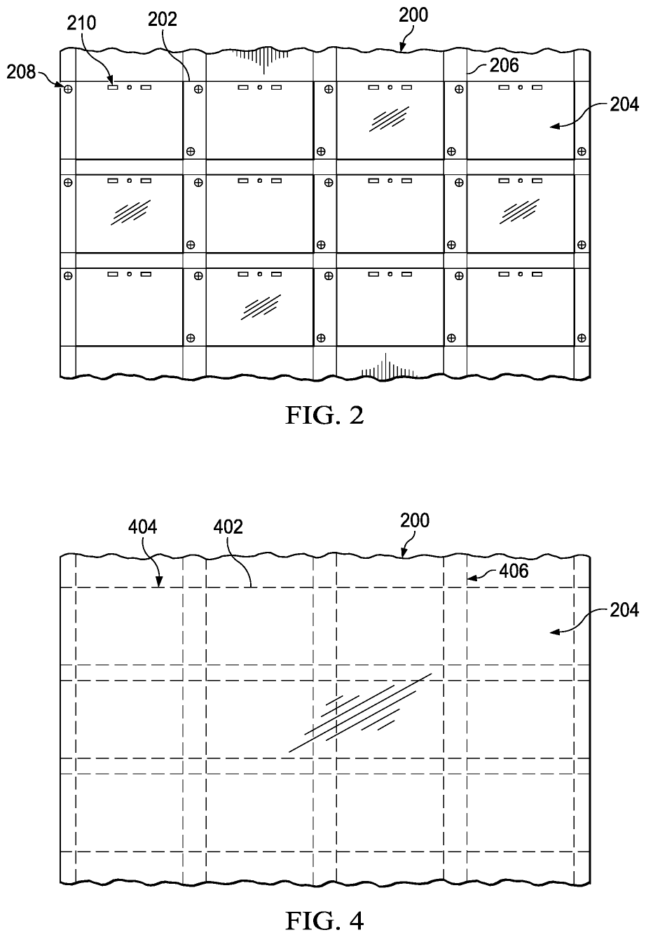

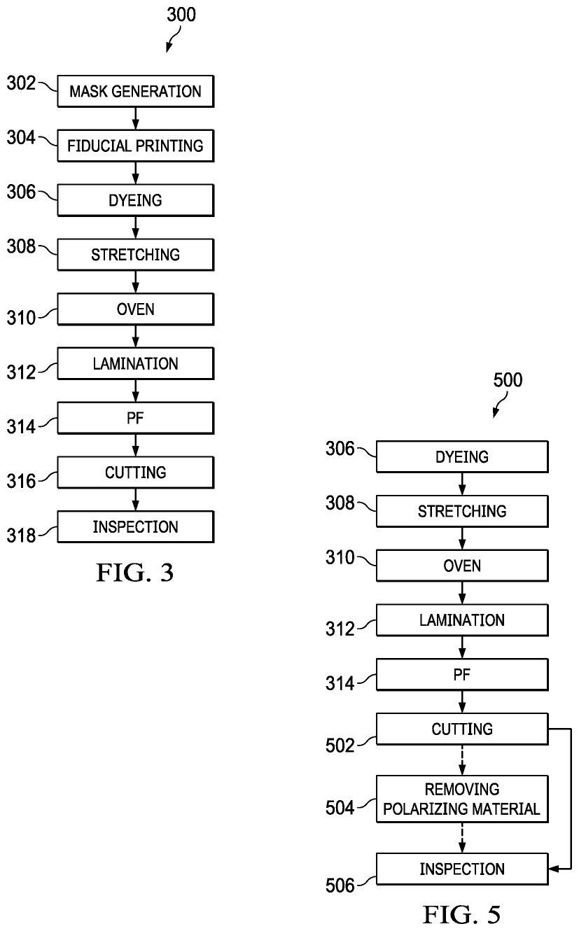

Referring to FIGS. 2 and 3, FIG. 2 depicts a base film substrate 200 configured with a set of optical targets for forming a polarizer film assembly 14 and FIG. 3 depicts a flow diagram of a method for manufacturing one embodiment of a polarizer film assembly 14 for use in a display assembly 100 for an information handling system. The display assembly 10 may have a camera or other optical sensor 22 that is negatively affected by a polarizer film. A camera could be a color (RGB) sensor/camera or an infrared (IR) sensor/camera, for example.

Base film substrate 200 may be, for example, polyvinyl alcohol (PVA) supplied in a continuous roll of material.

At step 302, a mask is formed on base film substrate 200 to form a set of unmasked areas 204 and a set of masked areas 210.

In some embodiments, a mask may be formed by material deposition onto base film substrate 200, wherein the material deposited on base film substrate 200 has properties that prevent a polarizer film from adhering to base film substrate 200. For example, in some embodiments, a mask may be formed by printing a layer of material onto base film substrate 200, wherein the printed material has surface properties that prevent a dye or other polarizer film to adhere to base film substrate. In some embodiments (not shown), as base film substrate 200 is unrolling, a material is deposited in a continuous strip. The strip may form a top border of a polarizing layer and may be wide to accommodate cutting tolerances in a polarizing layer.

In some embodiments, a mask may be formed by modifying base film substrate 200. For example, in some embodiments, a mask may be formed by polishing the surface of base film substrate 200 to have surface properties that prevent a polarizer film from adhering to base film substrate 200.

The shape of each masked area 210 may be based on ensuring a non-polarized area on a polarizer film assembly 14 aligns with a corresponding component in display assembly 100. For example, optical sensor 22 may benefit from a circular non-polarized area with a 5 mm diameter, but mechanical processing steps may stretch base film substrate 200. Accordingly, a masked area 210 corresponding to optical sensor 22 may be formed on base film substrate 200 as a non-circular masked area 210 and have a major diameter less than 5 mm to account for stretching and other changes to base film substrate 200.

At step 304, a set of optical targets may be formed on base film substrate 200 for correct alignment of base film substrate 200 relative to borders 202 and 206 for cutting base film substrate into polarizer film assemblies 14 in later manufacturing steps, discussed in greater detail below. In some embodiments, an optical target may be a masked area 210 located within borders 202, 206. In some embodiments, an optical target may be a fiducial 208 located outside borders 202, 206. In some embodiments, an optical target may be borders 202, 206. Borders 202, 206 may be lines printed on base film substrate 200 or may be defined by edges of unmasked areas 204. In some embodiments, one or more optical targets may be formed similar to masked areas 210 prevent the dye from adhering to base film substrate 200.

At step 306, a dye or other material used to form a polarizer film is applied to base film substrate 200. The dye may adhere to base film substrate 200 in a set of unmasked areas 204, but the mask prevents the dye from adhering to base film substrate 200 in the set of masked areas 210.

The process 300 to form polarizer film assembly 14 may include inspecting base film substrate 200 to verify the dye adhered to unmasked areas 204 and did not adhere to base film substrate 200 in the set of masked areas 210.

The process to form polarizer film assembly 14 includes other steps. For example, at step 308, base film substrate 200 may be stretched to align polarizer film in a desired direction. At step 310, base film substrate 200 may be placed in an oven for drying. Drying may ensure polarizer film stays adhered to base film substrate 200.

In some embodiments, material used to form a mask on base film substrate 200 may be removed. Mechanical and chemical processes needed to remove the mask may differ from mechanical and chemical processes needed to remove polarizer film deposited on unmasked areas 204, whereby removal of the mask may be less aggressive and use fewer resources and less time than removing polarizer film later.

At step 312, base film substrate 200 with a set of polarized areas and a set of non-polarized areas may be laminated with layers of tri-acetyl cellulose (TAC) or other material to protect the polarizer film. At step 314, a phase difference film (PF) may be applied to base film substrate 200. Other chemicals may be applied and other mechanical processes may occur to complete the manufacture of polarizer film assembly 14.

At step 316, base film substrate 200 may be cut into individual polarizer film assemblies 14, with each polarizer film assembly 14 being configured for assembly into display panel 100 such that a non-polarized area of polarizer film assembly 14 is positioned relative to an optical sensor 22. Cutting may include aligning base film substrate 200 to a cutter using the set of optical targets. The set of optical targets may include fiducials 208, non-polarized areas corresponding to masked areas 210 or borders 202, 206 of unmasked areas 204. In some embodiments, base film substrate 200 may have a continuous strip (not shown) formed along its length and the continuous strip may be used as an optical target for alignment. Aligning ensures cutting is along borders 202 and 206 relative to unmasked areas 204.

Once cut, each polarizer film assembly 14 has a polarizer film assembly width substantially equal to the display assembly width and a polarizer film assembly height substantially equal to the display assembly height, and at least one non-polarized area corresponding to a masked area 210 is positioned relative to an optical sensor 22.

Polarizer film assembly 14 be positioned relative to other layers in display assembly 100 to ensure display assembly 100 displays clear images and text in black and white or color and ensure optical sensor 22 is able to capture clear images and text in black and white or color. In some embodiments, backlight panel 12 may be assembled after polarizer film assembly 14 is assembled and after a printed circuit board assembly (PCBA) is assembled.

Embodiments described herein overcome several shortcomings of traditional approaches to manufacturing display assemblies.

Referring to FIGS. 4 and 5, FIG. 4 depicts a top view of base film substrate 200 without any markings, and FIG. 5 depicts a flow diagram of a common approach to manufacturing a polarizer film assembly.

As depicted in FIG. 5, at step 306, a dye or other polarizer film or film is applied to base film substrate 200. The dye may adhere to base film substrate 200 over the entire surface of base film substrate.

A traditional approach to form polarizer film assembly 14 includes other steps. For example, at step 308, base film substrate 200 may be stretched to align polarizer film in a desired direction. At step 310, base film substrate 200 may be placed in an oven for drying. Drying may ensure polarizer film stays adhered to base film substrate 200.

At step 312, base film substrate 200 comprising a continuous surface of polarizer film may be laminated with layers of tri-acetyl cellulose (TAC) or other material to protect the polarizer film. At step 314, a phase difference film (PF) may be applied to base film substrate 200. Other chemicals may be applied and other mechanical processes may occur to complete the manufacture of polarizer film assembly 14.

At step 502, base film substrate 200 may be cut into individual polarizer film assemblies 14, with each polarizer film assembly 14 being configured for assembly into display panel 100. Cutting may include operating a cutter to cut along lines 404 and 406 to form polarizer film assemblies 402.

Once cut, each polarizer film assembly 14 has a polarizer film assembly width substantially equal to the display assembly width and a polarizer film assembly height substantially equal to the display assembly height. However, polarizer film assemblies formed using traditional approaches may have polarizer film in front of optical sensors 22.

After cutting base film substrate 200 into polarizer film assemblies 402, at step 504, polarizer film is removed such that base film substrate 200 does not have polarizer film covering areas corresponding to optical sensor 22. Step 504 may require mechanical or chemical processes for removing polarizer film from base film substrate 400. These processes may be time consuming and could damage a polarizer film assembly during the final processing steps, which is undesirable for manufacturing costs.

In a first approach, manufacturers use mechanical, chemical or optical processes to remove polarizer film or film from selected areas of polarizer film assemblies 402. For example, one mechanical approach is to cut openings in the polarizer film assembly 402. This approach generally occurs after the base film substrate has been laminated between other layers of material and cut to its final size. Thus, there is more material to remove and the process can damage the polarizer film assembly 402. Also, unless there is a front layer 20 such as a bezel or cover glass, a user may see or feel a discontinuity on display panel 110, which may be unappealing.

A chemical approach is to use a chemical to remove a polarizer film from selected areas of base film substrate 200. However, using a chemical to remove a polarizer film from an area surrounded by an area with the same polarizer film is difficult. A chemical process may still leave a film or change the feel of polarizer film assembly 14 such that a user can see or feel a discontinuity or additional processing steps are necessary.

After step 504, step 506 may include inspecting a polarizer film assembly to ensure polarizer film has been removed such that polarizer film assembly 14 does not cover or negatively affect optical sensor 22.

The above disclosed subject matter is to be considered illustrative, and not restrictive, and the appended claims are intended to cover all such modifications, enhancements, and other embodiments which fall within the true spirit and scope of the disclosure. Thus, to the maximum extent allowed by law, the scope of the disclosure is to be determined by the broadest permissible interpretation of the following claims and their equivalents, and shall not be restricted or limited by the foregoing detailed description.

What is claimed is:

1. A method of manufacturing a polarizer film assembly for a display assembly having a display assembly width and a display assembly height, the method comprising:
forming a mask on a base film substrate to form a set of masked areas and a set of unmasked areas, wherein at least one masked area corresponds to a position of an optical sensor in the display assembly;
creating a set of optical targets on the base film substrate;
applying a dye to the base film substrate to form a set of polarized areas corresponding to the set of unmasked areas, wherein the mask prevents the dye from adhering to the base film substrate to form a set of non-polarized areas corresponding to the set of masked areas;
aligning the base film substrate relative to a cutter based on the set of optical targets; and
cutting the base film substrate relative to the set of optical targets to form the polarizer film assembly with a polarizer film assembly width substantially equal to the display assembly width and a polarizer film assembly height substantially equal to the display assembly height, wherein at least one polarized area is positioned relative to the optical sensor.

2. The method of claim 1, wherein forming a mask on a base film substrate comprises depositing a material on the base film substrate prior to prior to applying the dye to the base film substrate to prevent the dye from adhering to the base film substrate.

3. The method of claim 2, wherein forming a mask on a base film substrate comprises depositing a material in a continuous strip on the base film substrate prior to applying the dye to the base film substrate to prevent the dye from adhering to the base film substrate, wherein the continuous strip forms an optical target in the set of optical targets.

4. The method of claim 2, further comprising removing the deposited material after applying the dye.

5. The method of claim 1, wherein forming a mask on a base film substrate comprises modifying the base film substrate to prevent the dye from adhering to the base film substrate.

6. The method of claim 5, wherein modifying the base film substrate comprises polishing the base film substrate to form the set of masked areas.

7. The method of claim 1, wherein modifying the base film substrate comprises modifying a continuous strip of the base film substrate, wherein the continuous strip forms an optical target in the set of optical targets.

8. The method of claim 1, wherein:
creating a set of optical targets on the base film substrate comprises creating a set of borders and creating a set of fiducials outside the set of borders;
aligning the base film substrate relative to cutter based on the set of optical targets comprises aligning the base film substrate based on the set of fiducials; and
cutting the base film substrate relative to the set of optical targets comprises cutting along the set of borders.

9. The method of claim 1, wherein:
creating a set of optical targets on the base film substrate comprises creating a set of borders and identifying one or more masked areas as a set of fiducials inside the set of borders;
aligning the base film substrate relative to a cutter based on the set of optical targets comprises aligning the base film substrate based on the set of fiducials; and
cutting the base film substrate relative to the set of optical targets comprises cutting along the set of borders.

10. The method of claim 1, wherein the optical sensor comprises a camera.

11. A method of manufacturing a display assembly for an information handling system, the method comprising:
forming a polarizer film assembly comprising a polarizer film, comprising:
forming a mask on a base film substrate to form a set of masked areas and a set of unmasked areas, wherein at least one masked area corresponds to a position of an optical sensor in the display assembly;
creating a set of optical targets on the base film substrate;
applying a dye to the base film substrate to form the polarizer film on the set of unmasked areas, wherein the mask prevents the dye from adhering to the base film substrate in the set of masked areas;
aligning the base film substrate relative to a cutter based on the set of optical targets;
cutting the base film substrate relative to the set of optical targets to form a polarizer film assembly with a polarizer film assembly width substantially equal to the display assembly width and a polarizer film assembly height substantially equal to the display assembly height; and
assembling the polarizer film assembly in the display assembly, wherein the at least one masked area is positioned relative to the position of the optical sensor.

12. The method of claim 11, wherein forming a mask on a base film substrate comprises depositing a material on the base film substrate prior to applying the dye to prevent the dye from adhering to the base film substrate.

13. The method of claim 12, wherein forming a mask on a base film substrate comprises printing on the base film substrate prior to applying the dye to prevent the dye from adhering to the base film substrate.

14. The method of claim 11, wherein forming a mask on a base film substrate comprises modifying the base film substrate to prevent the dye from adhering to the base film substrate.

15. The method of claim 14, wherein modifying the base film substrate comprises polishing the base film substrate to form the set of masked areas.

16. The method of claim 11, wherein modifying the base film substrate comprises etching the base film substrate to form the set of masked areas.

17. The method of claim 11, wherein:
creating a set of optical targets on the base film substrate comprises creating a set of borders corresponding to the polarizer film assembly width and the polarizer film assembly height and creating a set of fiducials outside the set of borders;
aligning the base film substrate relative to a cutter based on the set of optical targets comprises aligning the base film substrate based on the set of fiducials; and
cutting the base film substrate relative to the set of optical targets comprises cutting along the set of borders.

18. The method of claim 11, wherein:
creating a set of optical targets on the base film substrate comprises creating a set of borders and identifying one or more masked areas as a set of fiducials inside the set of borders;
aligning the base film substrate relative to a cutter based on the set of optical targets comprises aligning the base film substrate based on the set of fiducials; and
cutting the base film substrate relative to the set of optical targets comprises cutting along the set of borders.

19. The method of claim 11, wherein the display assembly comprises a liquid crystal display (LCD) layer, wherein the polarizer film assembly is positioned in front of the LCD panel.

20. The method of claim 11, wherein the display assembly comprises a liquid crystal display (LCD) layer, wherein the polarizer film assembly is positioned between the LCD panel and a backlight panel.
